(19) United States
(12) Patent Application Publication
(10) Pub. No.: US 2019/0048864 A1
(43) Pub. Date: Feb. 14, 2019

(54) HYDRAULIC SYSTEM, SMART POWER UNIT AND OPERATION METHOD OF THE SYSTEM

(71) Applicant: HYDRONIT S.R.L., Varedo (MB) (IT)

(72) Inventors: Gianluca ALFIERI, Varedo (MB) (IT); Andrea GAMBUSERA, Varedo (MB) (IT)

(21) Appl. No.: 16/086,465

(22) PCT Filed: Mar. 24, 2016
(86) PCT No.: PCT/EP2016/056622

§ 371 Date: Sep. 19, 2018

(51) Int. Cl. F04B 41/00; F15B 13/08; F15B 21/08

(52) U.S. Cl. CPC F04B 41/00; F15B 13/0839; F15B 21/085; F15B 2211/20515; F15B 2211/2053; F15B 2211/6336; G05B 2219/25312; F15B 2211/6651; F15B 2211/6656; F15B 2211/7135; F15B 2211/75; F15B 2211/76; F15B 2211/765; F15B 2211/6346

(57) ABSTRACT

A hydraulic system with a hydraulic power pack is disclosed having a hydraulic pump, an electric motor arranged to drive the hydraulic pump, and one or more valves connected to the hydraulic pump and arranged to directly manage, by way of direct connections and respective actuators. The hydraulic system also has a hydraulic process computer arranged to control the one or more actuators by way of the valves. An operation method of the system is also disclosed.

### TECHNICAL FIELD

The present invention relates, in general, to a hydraulic system which comprises a smart power unit arranged to control the system.

In particular, present invention relates to a Smart Power Unit also named SPU arranged to control the hydraulic system by way of on board electronic circuits.

### BACKGROUND ART

Hydraulic systems comprising pump stations are known in many and different fields of technology.

The known hydraulic systems may comprise pump stations having power ranging from 0.15 kW to 7.5 kW and electric control units arranged to control pumps or systems.

In the field of hydraulic systems, for instance, document CN_102566541_A discloses an electric control system or unit of a hydraulic station which includes a power source, a control module and a working module in signal connection with the control module.

According to the known document, the working module includes a heater, an electromagnetic water valve, and an oil pump motor set, wherein the oil pump motor set includes a first oil pump motor, a second oil pump motor and a third oil pump motor.

Moreover, according to the known document, the control module includes a PLC (programmable logic control) unit, a heater failure control unit for protecting the heater, an oil pump failure control unit for protecting the oil pump motor set and an oil level/temperature control unit.

The known electric control system is arranged, in particular, to protect the oil pump motor set as well as to control level and temperature of oil.

According to the known document, the electric control system comprises a very limited number of features and is arranged, in particular, to protect the oil pump motor set by controlling level and temperature of oil.

As a matter of fact, the features of the known electric control system seem strictly linked to pump features and not flexible enough to be integrated in complex and different hydraulic systems.

As a matter of fact, a problem exists if the known electric control system needs to be integrated in hydraulic systems requiring, for instance, further devices.

As a matter of fact the features of the known electric control system are not enough flexible to be easily integrated in and applicable to complex hydraulic systems and, prima facie, strong engineering effort would be required to adapt the known electric control system to complex hydraulic systems in different fields of technology.

Applicant, in general, has noted that known hydraulic systems are not flexible and require electric control units more flexible.

Moreover, Applicant has noted that known electric control units of hydraulic systems do not effectively solve the problem to be very flexible and such to be simply integrated in complex and different hydraulic systems.

### DISCLOSURE OF THE INVENTION

The object of the present invention is thus to solve the problems outlined above.

According to present invention, such an object is achieved by means of a hydraulic system and a smart power unit having the features set forth in the claims that follow.

The present invention also relates to an operation method of the system, as claimed.

Claims are an integral part of the teaching of the present invention.

The following summary of the invention is provided in order to provide a basic understanding of some aspects and features of the invention. This summary is not an extensive overview of the invention, and as such it is not intended to particularly identify key or critical elements of the invention, or to delineate the scope of the invention. Its sole purpose is to present some concepts of the invention in a simplified form as a prelude to the more detailed description that is presented below.

According to a feature of a preferred embodiment the hydraulic system comprises a hydraulic power pack comprising an hydraulic pump and one or more valves arranged to directly manage, by way of direct connections, one or more respective actuators under control of a hydraulic process computer.

According to a further feature the hydraulic process computer of the system comprises a computer board that is programmable and comprises a Safety Architecture arranged to provide a relative level of risk-reduction features.

According to another feature the hydraulic process computer comprises a body including the computer board and a sensor board wherein the sensor board is arranged to shape one side of the body.

### BRIEF DESCRIPTION OF DRAWINGS

These and further features and advantages of the present invention will appear more clearly from the following detailed description of preferred embodiments, provided by way of non-limiting examples with reference to the attached drawings, in which components designated by same or similar reference numerals indicate components having same or similar functionality and construction and wherein:

FIG. 1 shows an external view of parts of a hydraulic system according to the invention;

FIG. 2 schematically shows a general block diagram of the hydraulic system according to the invention;

FIG. 3 schematically shows a detailed block diagram of one embodiment of the hydraulic system;

FIG. 4 shows a first installation example of the hydraulic system of FIG. 2; and

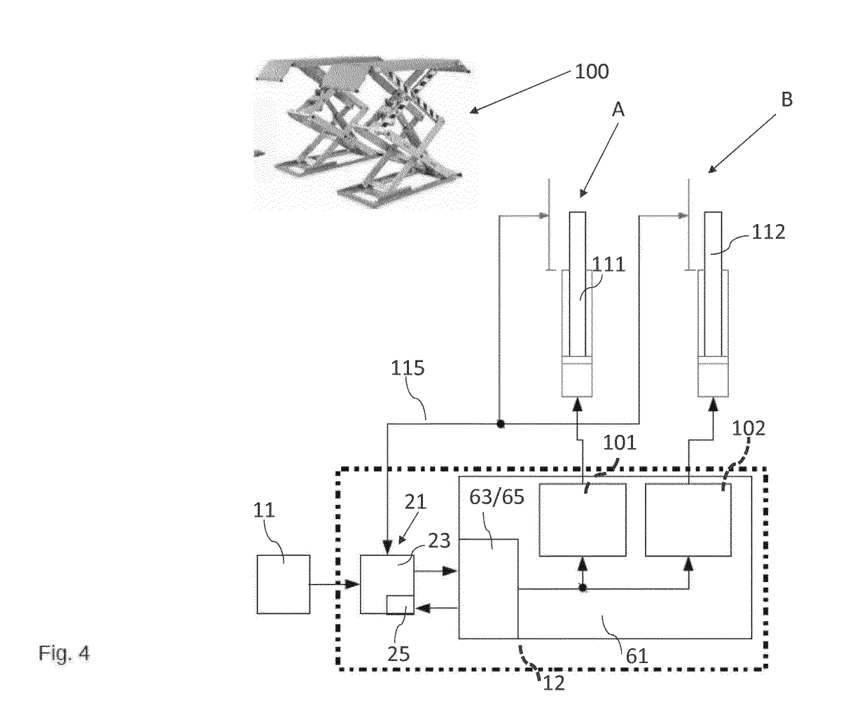

FIG. 5 shows a second installation example of the hydraulic system of FIG. 2.

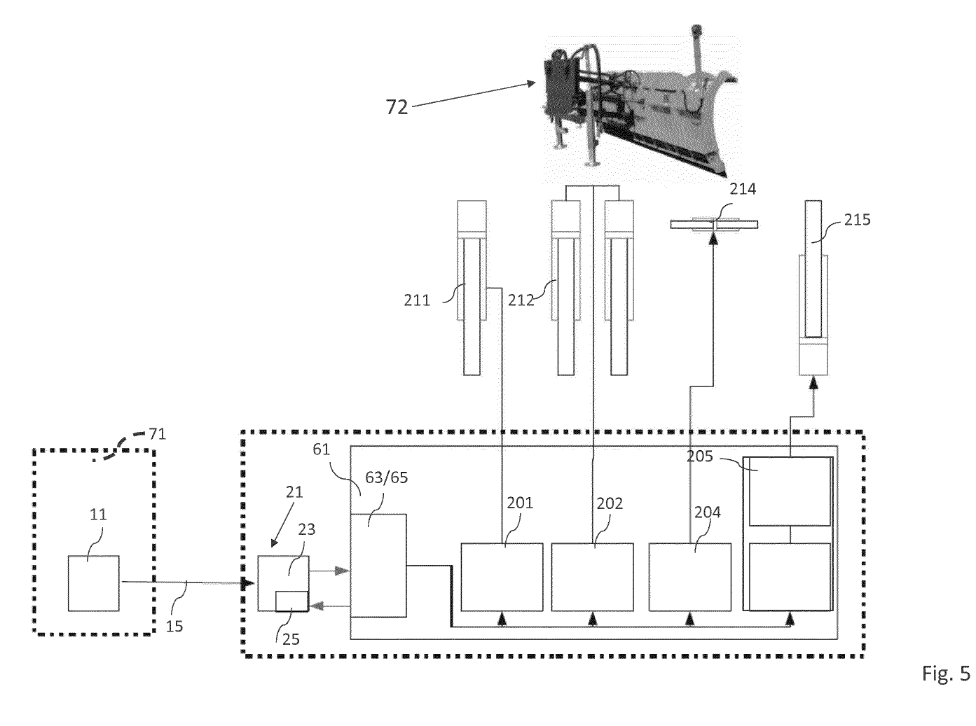

### BEST MODES FOR CARRYING OUT THE INVENTION

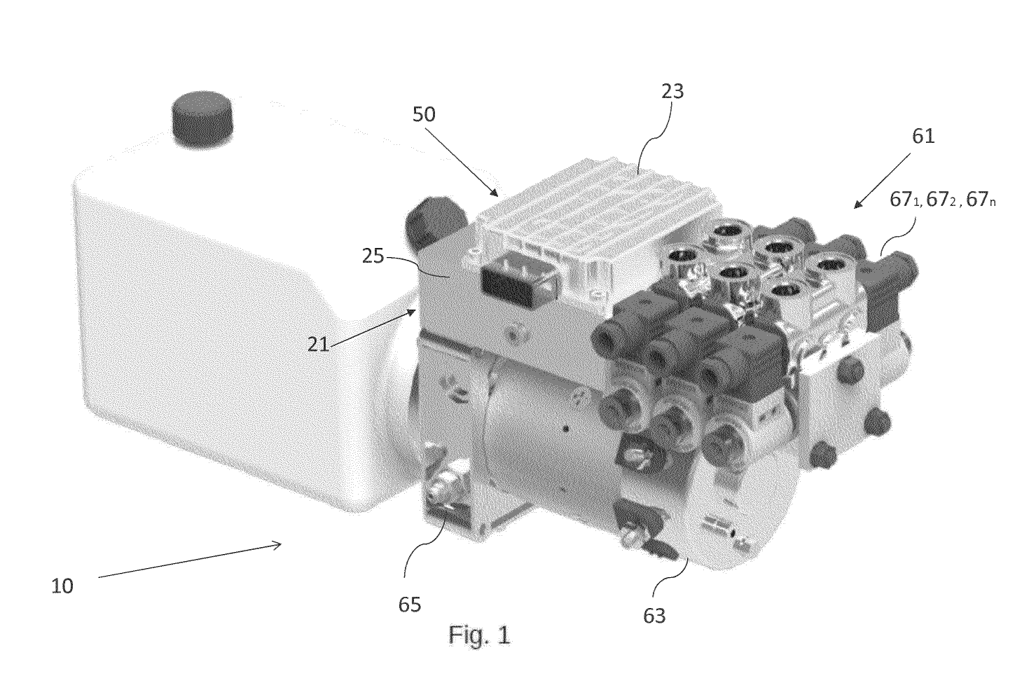

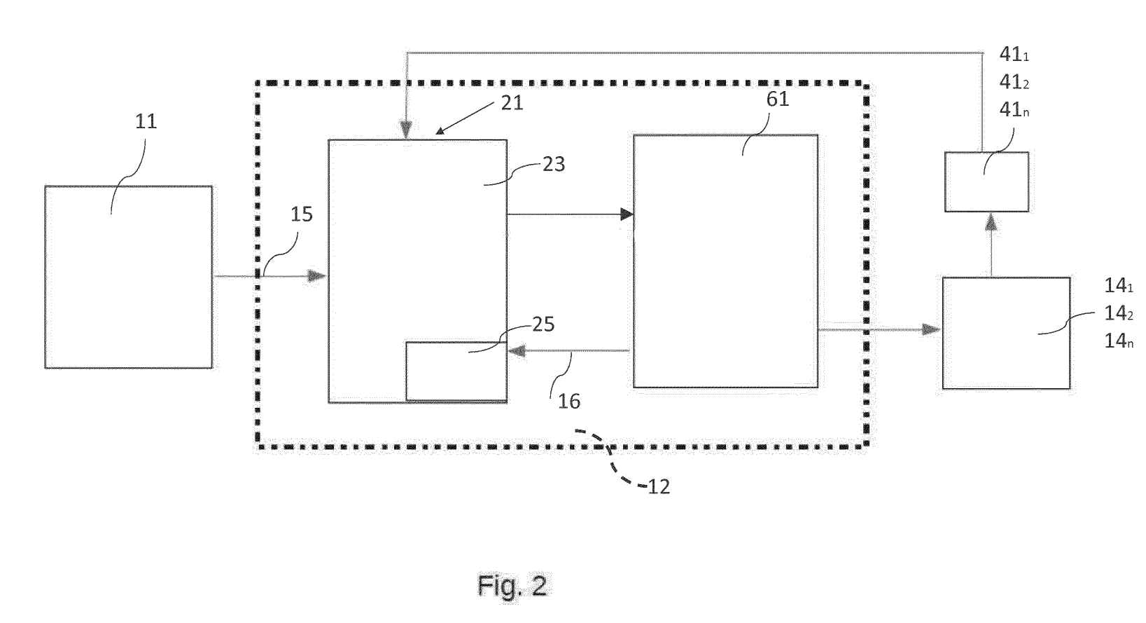

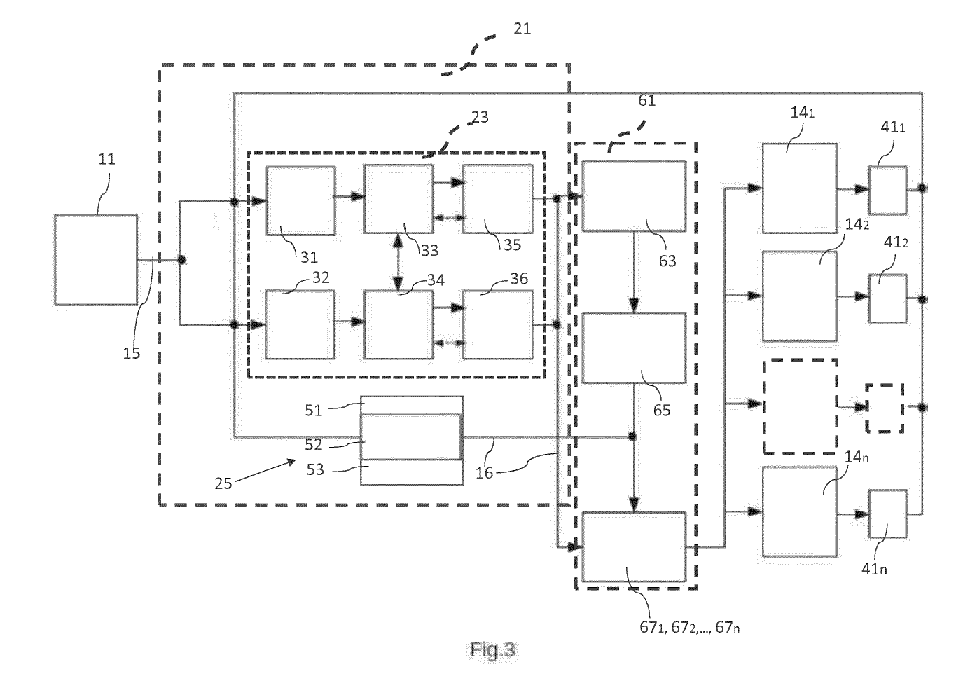

With reference to FIG. 1 a hydraulic system 10 according to present invention comprises a smart power unit or SPU 12, one or more actuators 141, 142, . . . , 14n, (FIG. 1, FIG. 2, FIG. 3), connected or associated to respective sensors 411, 412, . . . , 41n, and a human machine interface or HMI 11.

The hydraulic system 10 is arranged to be used by an operator in a machine or an electro-mechanic system or device to perform, for instance, motion/control activities. The HMI 11 is an operator interface, is connected to the SPU 12, and is arranged, for instance, to enable or disable functions, set values and/or limits, communicate warnings and/or alarms.

The HMI 11 comprises, for instance, START/STOP switches, joysticks, potentiometers, or any kind of components arranged to send commands to or receive information from SPU 12.

According to further embodiments, the HMI 11 further comprises a display arranged to display commands or status of commands sent to the SPU 12 as well as information, warnings or alarms received by the SPU 12.

According to the preferred embodiment the HMI 11 is connected to the SPU 12 by way of a BUS or a network (BUS) 15, for instance a CAN (Controller Area Network) BUS of known type or a wired or wireless network of known type.

The SPU (Smart Power Unit) 12, according to the preferred embodiment, comprises a hydraulic process computer or HPC 21 connected to the HMI 11 by way of the BUS 15, and a hydraulic power pack or HPP 61 connected, preferably by way of input/output wires 16, to the HPC 21.

The HPC 21 preferably comprises a programmable computer board (computer board) 23 and a sensor board 25 directly connected to the computer board 23.

In particular, the computer board 23, according to the preferred embodiment of present invention, is comprised in a body 50, for instance a waterproof body, and the sensor board (hydraulic manifold) 25 is arranged to shape one side of the body 50.

The computer board 23, according to the preferred embodiment, comprises a Safety Architecture arranged to provide a relative level of risk-reduction features.

For instance the Safety Architecture may comprise a known type SIL (Safety Integrity Level) 2 architecture, in order to provide a relative level of risk-reduction to the operation of the SPU 12 and of the hydraulic system 10.

Preferably, the computer board 23 comprises, for instance, a first 31 and a second input array 32 each associated to a respective first 33 and second logic processor 34 in cascade connection to a respective first 35 and second output 36.

The first 35 and second output 36, for instance first and second power outputs, are arranged to directly drive components comprised into the HPP 61, as for instance solenoid operated proportional or on-off valves 671, 672, . . . , 67n without the need of external devices.

According to the preferred architecture, the first 33 and second logic processor 34 are programmable and are arranged to be customized to the machine or to the electro-mechanic system or device where the hydraulic system 10 is installed.

Preferably the first 33 and second logic processor 34 are communicating each other and are arranged to operate a cross and redundancy check of received information.

For instance the communication between the first 33 and second logic processor 34 is made according to the SIL 2 architecture.

According to further embodiments the computer board 23 is programmable but comprises an architecture with only one input array, one logic processor and one output and is configured for providing, in any case, a certain safety integrity level corresponding to a certain risk-reduction.

The sensor board or hydraulic manifold 25, according to the preferred embodiment of present invention, comprises, for instance, one pressure sensor 51, one temperature sensor 52 and a return-line hydraulic flow sensor 53 or at least one type of the above sensors and is connected to the computer board 23 by way of input ports of input arrays 31, 32.

Preferably, the computer board 23 is laying on the hydraulic manifold 25 and is arranged to read sensors 51, 52 or 53 by way of the input ports.

In summary, according to the preferred embodiment of present invention, the sensor board or hydraulic manifold 25 comprises one or more sensors 51, 52 or 53, and is arranged to shape, for instance, a waterproof side of the body 50 including the computer board 23.

The sensor board, in general, is arranged to sense operation parameters of the HPP 61 and is strongly connected to the computer board 23.

The HPP 61 is comprised of a hydraulic power pack, for instance a mini or micro power pack, and is directly controlled by the HPC 21.

According to the preferred embodiment of present invention the HPP 61 comprises one or more of the following components:
an electric motor 63 sized upon the hydraulic system 10 necessities, for instance both an AC or a DC type motor, controlled by the HPC 21;
a hydraulic pump 65 sized upon the system necessities, and driven by the electric motor 63 by way of a connection of know type;
one or more valves 671, 672, . . . , 67n selected and applied in order to meet hydraulic system requirements, connected in known way to the pump 65, and controlled by the HPC 21; Valves 671, 672, . . . , 67n may further comprise security valves arranged to meet security requirements of the hydraulic system. One or more of valves 671, 672, . . . , 67n of the HPP 61, preferably, are directly connected to respective actuators 141, 142, . . . , 14n by way, for instance, of one or two respective pipes and are arranged to directly manage the respective actuators 141, 142, . . . , 14n.

The actuators 141, 142, . . . , or 14n may be of linear type (cylinders) or of rotary type (motors), known per se.

According to the preferred embodiment actuators 141, 142, . . . , or 14n comprise or are associated to respective sensors 411, 412, . . . , 41n, for instance position, force, or angle type integral sensors.

Preferably, each sensor 411, 412, . . . , or 41n, is arranged to send feedback information by way of input arrays, 31, 32, to the HPC 21 that is configured for performing motion/force control of the actuators 141, 142, . . . , or 14n in closed loop through valves 671, 672, . . . , 67n.

According to further embodiments the integral sensors 411, 412, . . . , or 41n, are totally or partially missing and/or are distributed in different parts of the machine or of the electro-mechanic system or device.

Operation of the hydraulic system 10 according to the preferred embodiment disclosed above is the following.

HMI 11 is mainly arranged to send operative instructions to SPU 12 by way of the BUS 15.

Thanks to such an architecture the HMI 11 may be located near the operator, for instance in a cabin, and SPU 12 may be located far from the HMI 11 and near the electro-mechanic system or device, without requiring very long and complex cables.

Following the operative instructions, the HPC 21 is arranged to directly send respective commands to the electric motor 63 and, by way of the valves 671, 672, . . . , 67n, to the actuators 141, 142, . . . , or 14n.

Thanks to such an architecture the hydraulic system 10 does not require relays and switches located far from the HPP 61 for controlling the machine or the electro-mechanic system or device and the HPP 61 of the SPU 12 is arranged to directly control actuators 141, 142, . . . , or 14n.

In use, the sensor board 25, being preferably integrated in or waterproof connected to the body 50, is arranged to directly feedback operation parameters of the pump 65 or of the HPP 61 to the computer board 23 and/or to the HMI 11.

Thanks to such high level of integration, for instance pump operation parameters are promptly recognised and managed by the computer board 23 and/or displayed by the HMI 11.

Sensors 411, 412, . . . , or 41n, associated to the actuators 141, 142, . . . , or 14n are arranged to send feedback information in closed loop to the computer board 23 so that any abnormality may be recognised and managed.

In particular, in case that the computer board comprises at least two logic processors configured according to a safety architecture implementing level 2 risk-reduction features, any abnormality is evaluated and managed by two logic processors in parallel.

In order to better clarify operation of the hydraulic system 10, two examples of possible installation of the SPU according to present invention are shown.

A first example relates to a SPU installed in a electrohydraulic twin-scissor lift 100 for vehicles comprising a master cylinder 111 and a slave cylinder 112.

According to known prior art, a twin-scissor lift is normally developed on a principle of “emitter” and “receiver” slave cylinders.

The emitter cylinder is mechanically connected to a master cylinder located in a platform A which drives the platform out (while lifting) or in (while lowering).

The emitter cylinder pumps oil on the receiver slave cylinder located in platform B which drives the scissor.

Eventual unbalanced load is compensated by a torsion bar.

Therefore, according to known prior art, the conventional twin-scissor lift comprises three cylinders:
an emitter cylinder,
a receiver cylinder, and
a master cylinder.

On the contrary, the SPU 12 of present invention, applied to a twin-scissor lift 100, may replaces the emitter and receiver hydraulic cylinders and the torsion bar by way of a single cylinder (slave cylinder) 112 of the same size of the master cylinder 111.

As a matter of fact, the computer board 23, thanks to the fact that it is of programmable type, may be configured to synchronise the position of the slave cylinder 112 to the position the master cylinder 111 by conveniently managing signals of a sensor 115 sending back information from cylinders 111 and 112 to the computer board 23.

Therefore, the SPU 12 may be configured to drive only two cylinders.

The slave cylinder 112 is driven, for instance by a 3/2 proportional valve 102 comprised into the HPP 61.

According to the example the sensor 115, for instance, is a rotative potentiometer, arranged to determine the actual scissor height.

Moreover, according to the example, the HPC 21 of the SPU 12 is arranged to manage lifting lowering of the master cylinder and parallelism of the slave cylinder through respective proportional valves 101, 102.

Advantageously, the SPU 12 allows to reduce manufacturing costs and manpower, simplifies the mechanical solution and reduces hardware materials and spare parts.

A second example relates to a SPU installed, for instance, in a snowplow comprising a cabin 71 and at least one blade controlled by an electro-mechanic device 72.

According to known prior art, a snowplow is normally powered by a conventional hydraulic power pack driven by an electro-mechanic system by way of relays and switches.

Therefore in the vehicle cabin a control panel remotely controls the electro-mechanic device.

The electro-mechanic device, according to prior art, requires at least one wire per each function and other three wires for power. In summary, a fully equipped snowplow can comprise a twenty poles cable for connecting the control panel to the electro-mechanic device; such a cable requires hard work to be driven from inside the cabin to the blade of the snowplow and also requires chassis modification and expansive multiway connectors.

On the contrary, a snowplow designed so as to comprise a SPU 12 according to present invention, comprises, for instance, the HMI 11 located into the cabin 71.

The HMI 11 is arranged to manage all the snowplow functions by way of the SPU 12 located near the electro-mechanic device 72 and connected to the HMI 11 through the BUS 15, for instance through the CAN-BUS.

Therefore, advantageously, the hydraulic system according to present invention, when applied to a snowplow requires:
Minor chassis modification of the snowplow, i.e. less manufacturing costs;
Lower connectors cost;
Smaller design effort.

In addition, according to further features of the preferred embodiment of present invention, the direct connection of the SPU to actuators of the snowplow, for instance a scraper 211, a first and second outrigger 212, an orient 214 and a lift/low 215 through respective valves 201, 202, 204 and 205 comprised into the HPP 61, is such to grant:
very high serviceability.

Moreover, the SPU 12, by preferably comprising the sensor board 25 tightly connected to the computer board 23, is such to grant when installed in a snowplow:
very effective diagnostic features.

Of course, other examples or obvious changes and/or variations to the above disclosure are possible, as regards architecture components and connections as well as details of the described construction and operation method without departing from the scope of the invention as defined by the claims that follow.

1. A hydraulic system comprising:
a hydraulic power pack comprising a hydraulic pump and an electric motor arranged to drive the hydraulic pump, and
a hydraulic process computer comprising a computer board, said hydraulic process computer being arranged to control said electric motor,
wherein
said hydraulic power pack further comprises one or more valves connected to the hydraulic pump and arranged to directly manage, by way of direct connections, one or more respective actuators under control of said hydraulic process computer.

2. The hydraulic system according to claim 1, wherein
said one or more actuators are associated to respective sensors arranged to send feedback information to said hydraulic process computer, and
said hydraulic process computer is configured for performing motion/force control of the actuators on the basis of said feedback information and in closed loop, by way of said valves.

3. The hydraulic system according to claim 1, further comprising:
a human machine interface arranged to enable or disable functions, set values and/or limits, communicate warnings and/or alarms, and
a BUS or a network connection arranged to connect said human machine interface to said hydraulic process computer.

4. The hydraulic system according to claim 1, wherein said hydraulic process computer comprises:
a logic processor configured according to a safety architecture.

5. The hydraulic system according to claim 1, wherein said computer board comprises at least two logic processors configured according to a safety architecture implementing level 2 risk-reduction features.

6. The hydraulic system according to claim 1, wherein said hydraulic process computer further comprises:
a body comprising the computer board and a sensor board, said sensor board being arranged to shape one side of the body.

7. A smart power unit for a hydraulic system comprising:
a hydraulic power pack comprising a hydraulic pump and an electric motor arranged to drive the hydraulic pump, and
a hydraulic process computer comprising a computer board, said hydraulic process computer being arranged to control at least said electric motor,
wherein said computer board comprises a Safety Architecture arranged to provide a relative level of risk-reduction to the operation of the smart power unit.

8. The smart power unit according to claim 7, wherein said hydraulic process computer further comprises:
a body comprising the computer board and a sensor board arranged to sense operation parameters of said hydraulic power pack, and wherein
said sensor board is arranged to shape one side of the body.

9. The smart power unit according to claim 7, wherein
said hydraulic power pack further comprises one or more valves connected to the pump and arranged to meet certain hydraulic requirements, and wherein
said one or more valves are controlled by said hydraulic process computer.

10. A method of operating a hydraulic system comprising the steps of:
providing a hydraulic power pack comprising:
a hydraulic pump,
one or more valves connected to the hydraulic pump;
providing a hydraulic process computer arranged to control said hydraulic pump and said one or more valves,
providing one or more actuators directly and respectively connected to said one or more valves, and
directly managing said one or more actuators by way of said one or more valves.

11. The method according to claim 10 further comprising the steps of:
providing one or more sensors respectively associated to said one or more actuators,
sending feedback information to said hydraulic process computer, and
performing motion/force control of the actuators in closed loop by way of said valves under control of said hydraulic process computer.

12. The method according to claim 10, further comprising the steps of:
connecting a human machine interface, arranged to enable or disable functions, set values and/or limits, communicate warnings and/or alarms, to said hydraulic process computer by way of a BUS or a network connection.

13. The method according to claim 10, further comprising the steps of:
providing said hydraulic process computer with a Safety Architecture, and
arranging a relative level of risk-reduction to the operation method of the hydraulic system by way of said Safety Architecture.

14. The method according to claim 10, wherein the step of:
providing a hydraulic process computer comprises the steps of:
providing a computer board,
providing a sensor board directly connected to the computer board, and
sensing operation parameters of the hydraulic power pack by way of the direct connection to the computer board.

15. The method according to claim 14 further comprising the step of:
providing a body including the computer board and the sensor board, and
arranging the sensor board so as to shape one side of the body.
